(19) United States
(12) Patent Application Publication
(10) Pub. No.: US 2018/0361923 A1
(43) Pub. Date: Dec. 20, 2018

(54) VEHICLE INTERIOR PANEL

(71) Applicant: TOYOTA JIDOSHA KABUSHIKI KAISHA, Toyota-shi (JP)

(72) Inventors: Kosuke HAYASHIDA, Toyota-shi (JP); Akihide FUKUYAMA, Toyota-shi (JP); Koji KUDO, Toyota-shi (JP); Junichi MURASE, Tajimi-shi (JP)

(73) Assignee: TOYOTA JIDOSHA KABUSHIKI KAISHA, Toyota-shi (JP)

(21) Appl. No.: 16/003,400

(22) Filed: Jun. 8, 2018

(30) Foreign Application Priority Data
Jun. 16, 2017 (JP) 2017-118725

(51) Int. Cl. B60Q 3/78; B60Q 3/10; B60K 37/00

(52) U.S. Cl. CPC B60Q 3/78; B60K 37/00; B60Q 3/10

(57) ABSTRACT

A smartphone disposed in a passenger compartment includes a cable connecting to a USB receptacle provided in a vehicle. An instrument panel, which is an interior panel, includes a holding groove that receives and holds the cable of the smartphone. Movement of the cable can be restricted by holding the cable in the holding groove. A light emitting portion may be disposed along the holding groove to indicate the position of the holding groove in the dark.

### CROSS REFERENCE TO RELATED APPLICATION

The disclosure of Japanese Patent Application No. 2017-118725 filed on Jun. 16, 2017 including the specification, claims, drawings, and abstract is incorporated herein by reference in its entirety.

### TECHNICAL FIELD

The present disclosure relates to a vehicle interior panel, in particular, to a structure of the interior panel.

### BACKGROUND

In recent years, mobile electronic devices for individual use have come into widespread use, increasing opportunities to use or charge these devices in vehicles. A cable is used to connect between a vehicle and a mobile electronic device to charge the electronic device or communicate with the vehicle. Cables are used not only for those mobile electronic devices but also for supplying power to devices which were added afterwards in a vehicle compartment.

JP 2001-119464A discloses a phone holder (10) that holds a mobile phone for use in a vehicle compartment. A wire housing (16) for housing a spiral portion (32) of wire (30) is disposed below the phone holder (10). The wire (30) is guided out of the wire housing (16) through a wire outlet (16a) disposed at a lower end of a side wall of the wire housing (16). It should be noted that the above reference numbers in parentheses are used in JP 2001-119464A. The reference numbers do not relate to the reference numbers used in the description of the embodiments of the present disclosure.

### SUMMARY

### Technical Problem

A cable for connecting between a vehicle and a mobile electronic device or an on-board device added afterwards often has an extended line shape. It is desired to secure such a cable onto a vehicle interior panel to avoid movement of the cable. It is also desired to facilitate a procedure of securing the cable, even in the dark.

A first object of the present disclosure is to restrict movement of a cable that connects between a vehicle and a mobile electronic device or an on-board device added afterwards by holding the cable. When the first object is achieved, an additional second object is to make the position of a holding groove easily recognizable even in a dark environment.

### Solution to Problem

A vehicle interior panel according to the present disclosure includes a holding groove formed therein that can hold a cable connecting between a device in a vehicle compartment and the vehicle.

A light emitting portion may be disposed along at least a part of the holding groove.

The light emitting portion may be disposed at an opening edge portion of the holding groove.

The internal panel may include a step such that the holding groove may be formed at at least a part of a corner portion of the step.

The internal panel may include a panel body, and an instrument cluster that protrudes from the panel body to form a step. The holding groove may be formed at at least a part of a corner portion of the step.

The holding groove may be formed by a flexible holding member having a U-shaped cross section that is disposed in a receiving groove formed in the interior panel. The holding member and the light emitting portion may be united.

The holding groove may include, between an opening top portion and a bottom portion, a portion having a narrower width than that of the bottom portion.

The interior panel may be an instrument panel.

### Advantageous Effects of Invention

Movement of a cable can be restricted by holding the cable in a holding groove formed in an interior panel. By providing a light emitting portion, the position of the holding groove becomes visible even in a dark environment, making the position of the holding groove easily recognizable. By disposing the holding groove at a corner of a step, the position of the holding groove becomes easily recognizable even in a dark environment.

### BRIEF DESCRIPTION OF DRAWINGS

Embodiments of the present disclosure will be described by reference to the following figures, wherein:

FIG. 1 shows a front portion of front seats in a vehicle compartment;

FIG. 2 shows a perspective view in which a center cluster of an instrument panel and its peripheral are enlarged;

FIG. 3 shows an example of a holding groove;

FIG. 4 shows another example of a holding groove;

FIG. 5 shows yet another example of a holding groove;

FIG. 6 shows an example of a light emitting portion disposed along a holding groove; and

FIG. 7 shows another example of a light emitting portion disposed along a holding groove.

### DESCRIPTION OF EMBODIMENTS

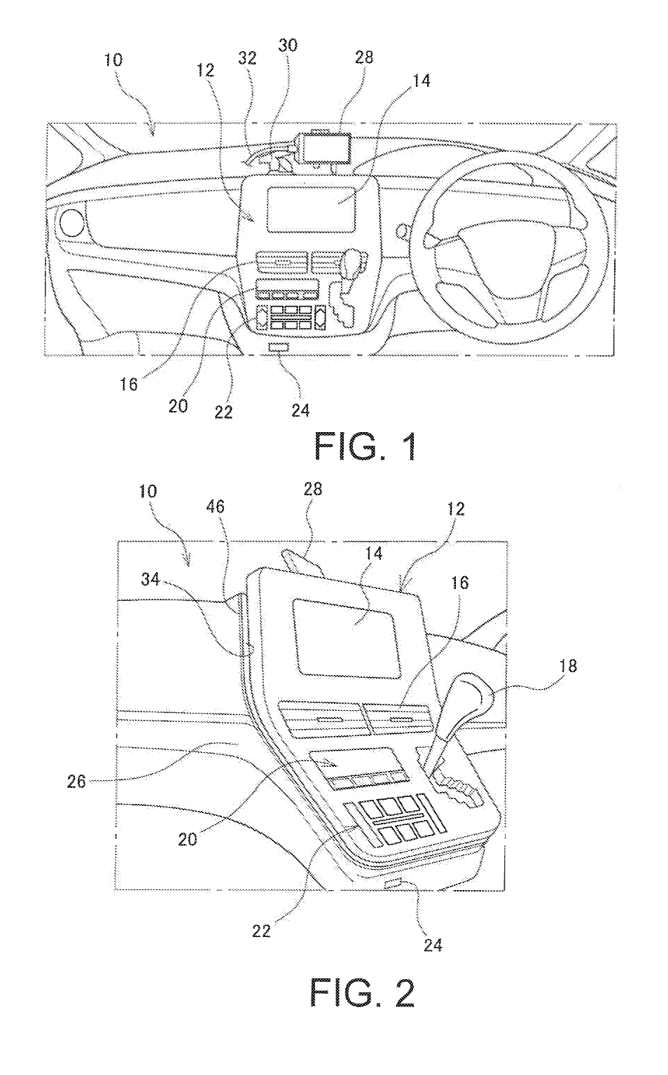

Embodiments of the present disclosure are described below by reference to the drawings. FIG. 1 shows a front portion of front seats of a vehicle; in particular, a passenger automobile. An interior material is disposed on a surface on the passenger compartment side of a vehicle body. The interior material is typically formed as a resin panel. A resin panel which partially uses leather, metal, wood, or other materials may also be used. The interior panel in front of front seats is referred to as an instrument panel 10. In the description below, the instrument panel 10 is described as an example of the interior panel.

The instrument panel 10 includes meters such as a speedometer, a fuel gauge, and an odometer, operation panels of an audio device and an air conditioner, lamps for displaying an operation status or an alarm of devices of the vehicle, and display screens for displaying various pieces of information. The instrument panel 10 may also include an air vent of an air conditioner and a lid of a storage of miscellaneous articles such as a glove compartment. The instrument panel 10 may further include a device for providing a power supply, such as a cigarette lighter socket and an accessory power outlet. A USB receptacle may also be provided. Operation switches and display screens are often positioned at a center portion of the instrument panel 10; in other words, at a center cluster 12 positioned between the right and left front seats.

FIG. 2 is a side perspective view of the center cluster 12. A display screen 14 capable of displaying a variety of pieces of information is disposed at an upper portion of the center cluster 12, and air vents 16 are disposed below the display screen 14. A shift lever 18 is provided on the right below the air vent 16. On the left of the shift lever 18, an audio device operation panel 20 is provided above an air-conditioner operation panel 22. The audio device operation panel 20 and the air-conditioner operation panel 22 may include operation switches such as a push button switch, a seesaw switch, and a rotary switch. A USB receptacle 24 is disposed below the center cluster 12 on the instrument panel 10. A cigarette lighter socket may be also disposed below the center cluster 12. The cigarette lighter socket can provide a power supply to electric devices used in the passenger compartment. As shown in FIG. 2, the center cluster 12 protrudes from a panel body 26 of the instrument panel 10 such that a step is formed between the center cluster 12 and the panel body 26.

In recent years, opportunities to use an electric device in a passenger compartment have increased. For example, mobile electronic devices such as a mobile information terminal, a mobile phone, a smartphone, and a tablet type computer are brought into a passenger compartment and used. An on-board device added afterwards such as a navigator or a dash cam which records views in front of a vehicle is also used in a passenger compartment. The USB receptacle 24 is disposed for supplying electric power to mobile electronic devices. When no USB receptacle 24 is provided, a converter can be attached to the cigarette lighter socket to connect a charging cable to the vehicle and a mobile electronic device via the converter. The USB receptacle 24 also enables information communications with the vehicle. The cigarette lighter socket may also be used to supply electric power to an on-board device added afterwards.

FIGS. 1 and 2 show a smartphone 28 disposed above the center cluster 12. The smartphone 28 is supported by a holder 30 which is secured to the instrument panel 10. A cable 32 connecting between the smartphone 28 disposed at this position and the USB receptacle 24 disposed at a lower portion of the instrument panel 10 may be an annoyance, in that the cable 32 may extend across the instrument panel 10. Further, when the vehicle accelerates, decelerates, or turns while driving, the cable 32 may be moved by inertia.

The instrument panel 10 includes a holding groove 34 formed therein for holding the cable 32 such that the cable 32 extends in a line-shape. The holding groove 34 may be formed in all or any of the top, the bottom, the right, and the left side surfaces of the center cluster 12. The holding groove 34 may have a groove width slightly narrower than the diameter of the cable 32. In this way, the cable 32 in the holding groove 34 can be squeezed by both of the side walls of the holding groove 34 to thereby be held inside the holding groove 34. In contrast, the holding groove 34 may have a groove width slightly wider than the diameter of the cable 32. Even with a wider groove width, the cable 32 can be held inside the holding groove 34 by friction or gravity. A typical diameter of the cable 32 is about 2 to 3 mm. The groove width of the holding groove 34 may be, for example, about 1.5 to 2.5 mm. The width of the holding groove 34 may be wide for most of the length and narrower at some points in the extending direction of the holding groove 34.

The holding groove 34 may be disposed along a step formed in the instrument panel 10; in particular, at a corner formed by the step. The position of the holding groove 34 becomes easily recognizable by positioning the holding groove 34 at the corner of the step.

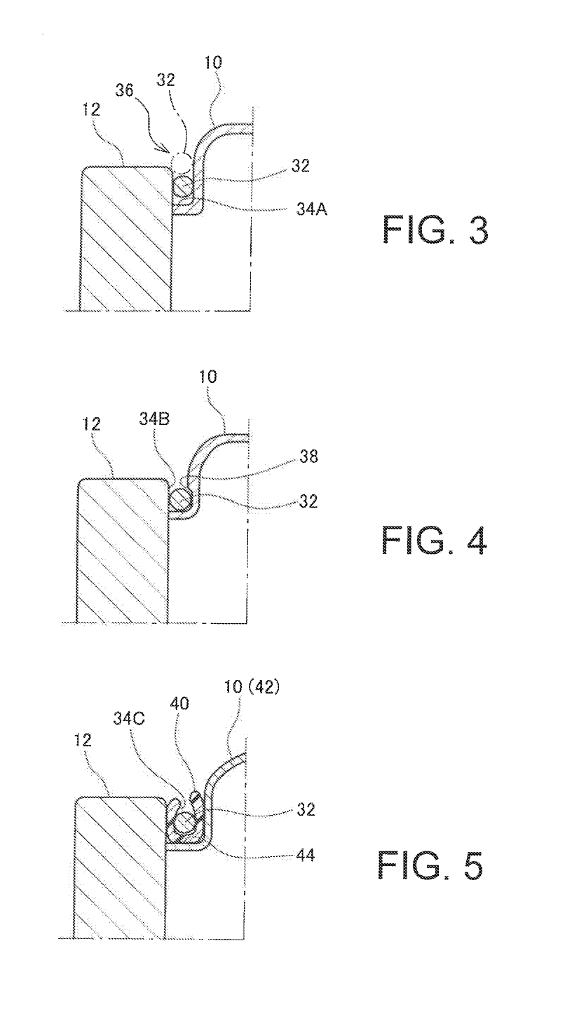

FIG. 3 shows a holding groove 34A which is an example of the holding groove 34, in an enlarged cross sectional view of an upper portion of an instrument panel. In the drawing, the internal structure of the instrument panel 10 and the center cluster 12 is omitted. The holding groove 34A is disposed at a corner portion 36 of the step formed by the instrument panel 10 and the center cluster 12. The holding groove 34A has a width slightly narrower than the diameter of the cable 32. In order to set the cable 32, the cable 32 should first be placed at the corner portion 36 at a position shown by the dash-dot line in FIG. 3, and then, the cable 32 should be pushed deeper into the holding groove 34A from that position. It is easy to place the cable 32 near the corner portion 36 of the step, even in the dark. From the position, pushing it further into the holding groove 34A, which is positioned deep at the corner portion 36, can be performed gropingly. By its own flexibility, the cable 32 is held in the holding groove 34A by being nipped by the side walls of the holding groove 34A.

FIG. 4 shows an enlarged cross sectional view of a holding groove 34B which is another example of the holding groove 34. Between an opening top portion and a bottom portion of the groove, the holding groove 34B includes a narrow portion 38 which is narrower in the width than the bottom portion. The narrow portion 38 can restrict falling of the cable 32, achieving more secured holding of the cable 32.

FIG. 5 shows an enlarged cross sectional view of a holding groove 34C which is yet another example of the holding groove 34. The holding groove 34C is an internal space formed by a flexible holding member 40 having a U-shaped cross section. The holding member 40 may be received in a receiving groove 44 formed in a panel member 42 of the instrument panel 10. The holding member 40 may be disposed continuously for the groove's entire length or partially with intervals. The holding member 40 may be secured inside the receiving groove 44 with adhesive. The holding member 40 may be made of a flexible material such as rubber or urethane.

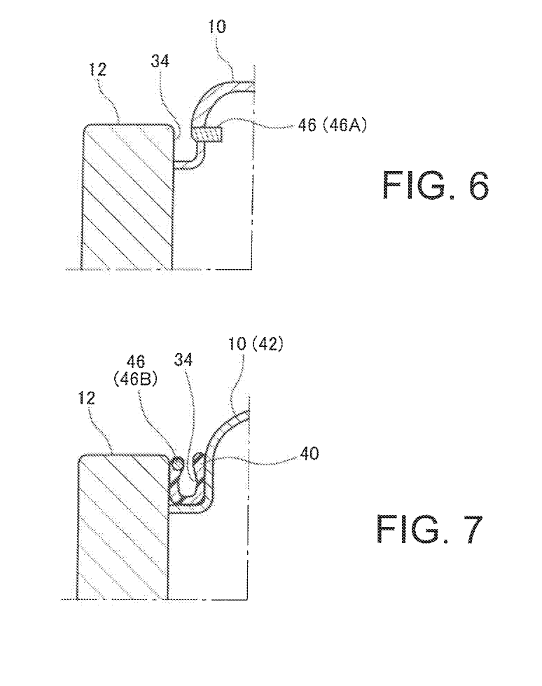

FIGS. 3 to 5 show embodiments in which the positions of the holding grooves 34A to 34C are made easily recognizable by disposing the holding grooves 34A to 34C at the corner portion 36 of the step. In addition to or instead of this, the position of the holding groove 34 may be indicated by disposing a light emitting portion 46 (refer to FIGS. 6 and 7) along the holding groove 34. The light emitting portion 46 may emit light from itself or guide light from a light source to a certain position. The light emitting portion 46 may have a line shape extending along the groove. Alternatively, two or more light emitting portions 46 may be disposed along the groove with intervals therebetween. The light emitting portion 46 may be disposed near an opening top portion or a bottom portion.

FIG. 6 shows an enlarged cross sectional view of a light emitting portion 46A which is an example of the light emitting portion 46. Although the shape of the holding groove 34 shown in the drawing is the same as that of the above-mentioned holding groove 34B in FIG. 4, the shape is not limited to this example. The light emitting portion 46A is disposed near an opening top portion of the holding groove 34. The light emitting portion 46A may be made of a rigid material such as acrylic to guide light from a separately provided light source.

FIG. 7 shows an enlarged cross sectional view of a light emitting portion 46B which is another example of the light emitting portion 46. Similarly as the above-mentioned holding groove 34C in FIG. 5, the holding groove 34 shown in the drawing is an internal space formed by the U-shaped holding member 40. The light emitting portion 46B may be unitarily formed with the holding member 40, such that the light emitting portion 46B is disposed continuously for the entire length of the holding member 40 or partially with intervals. The light emitting portion 46B may be provided as, for example, an organic EL tube of an organic electroluminescent material.

The light emitting portion 46 may be set to start light emission at a timing when a driver or passenger gets in a vehicle. For example, when the driver or passenger opens a door or is seated, an accessory switch is turned ON (that is, when electric power is supplied to audio or other devices), or an ignition switch is turned ON (when the vehicle is ready for driving).

In the embodiments described above, the holding groove 34 is described to be disposed on the instrument panel 10, in particular, on a side surface of the center cluster 12. However, the holding groove 34 may be disposed at another portion of the instrument panel 10 or on an interior panel other than the instrument panel 10. For example, the holding groove 34 may be disposed on another interior panel, such as a ceiling or an A-pillar, which is the front-most interior panel.

### REFERENCE SIGNS LIST

10 instrument panel, 12 center cluster, 14 display screen, 16 air vent, 18 shift lever, 20 audio device operation panel, 22 air-conditioner operation panel, 24 USB receptacle, 26 panel body, 28 smartphone, 30 holder, 32 cable, 34 holding groove, 36 corner portion of a step, 38 narrow portion, 40 holding member, 42 panel member, 44 receiving groove, and 46 light emitting portion.

1. A vehicle interior panel comprising a holding groove capable of holding a cable connecting between a device in a passenger compartment and a vehicle.

2. The vehicle interior panel according to claim 1, wherein at least one light emitting portion is disposed along at least a part of the holding groove.

3. The vehicle interior panel according to claim 2, wherein the at least one light emitting portion is disposed to extend along the holding groove.

4. The vehicle interior panel according to claim 2, wherein the at least one light emitting portion is disposed at a top opening edge portion of the holding groove.

5. The vehicle interior panel according to claim 1, wherein
the interior panel comprises a step, and
the holding groove is formed at at least a part of a corner portion of the step.

6. The vehicle interior panel according to claim 1, wherein
the interior panel comprises
a panel body; and
an instrument cluster that protrudes from the panel body to form a step, and
the holding groove is formed at at least a part of a corner portion of the step.

7. The vehicle interior panel according to claim 1, wherein the holding groove is formed by a flexible holding member having a U-shaped cross section that is disposed in a receiving groove formed in the interior panel.

8. The vehicle interior panel according to claim 2,
wherein the holding groove is formed by a flexible holding member having a U-shaped cross section that is disposed in a receiving groove formed in the interior panel, and
the at least one light emitting portion is united with the holding member.

9. The vehicle interior panel according to claim 1, wherein the holding groove comprises, between an opening top portion and a bottom portion, a portion having a narrower width than the bottom portion.

10. The vehicle interior panel according to claim 1, wherein the interior panel is an instrument panel.
